(19) United States
(12) Patent Application Publication
(10) Pub. No.: US 2012/0274243 A1
(43) Pub. Date: Nov. 1, 2012

(54) DRIVING CIRCUIT FOR VIBRATION APPARATUS

(75) Inventor: JUN SUMIOKA, YOKOHAMA-SHI (JP)

(73) Assignee: CANON KABUSHIKI KAISHA, TOKYO (JP)

(21) Appl. No.: 13/429,706

(22) Filed: Mar. 26, 2012

(30) Foreign Application Priority Data
Apr. 26, 2011 (JP) 2011-098141

(51) Int. Cl. H02N 2/06

(52) U.S. Cl. 318/116

(57) ABSTRACT

The present invention provides a driving circuit for a vibration apparatus which drives an object using a vibration wave generated by an electro-mechanical energy conversion element is equipped with an electrical resonance circuit, and which is capable of reducing harmonic components of an alternating voltage applied to an electro-mechanical energy conversion element. The electrical resonance circuit includes an electrostatic capacity of the conversion element, plural inductors connected in series with the conversion element, and a capacitor connected at one end between the plural inductors and connected in parallel with the conversion element. The electrical resonance circuit has at least two resonance frequencies including a first frequency and a second frequency and satisfies the relation:

f1<fd<f2

where f1 is the first frequency, f2 is the second frequency, and fd is a frequency of an alternating voltage.

### BACKGROUND OF THE INVENTION

1. Field of the Invention

The present invention relates to a driving circuit for a vibration apparatus.

2. Description of the Related Art

Recently, in imaging apparatus which are optical instruments, with improvement in the resolution of optical sensors, dirt and other foreign particles attaching to an optical system during use have come to affect photographic images.

In particular, the resolution of imaging devices used for video cameras and still cameras have been improving remarkably.

Consequently, if outside dust or inside wear debris produced on a mechanical sliding surface attaches to an optical part such as an infrared cut filter or optical low pass filter placed near the imaging device, since images do not blur much on a surface of the imaging device, the dust might appear in photographic images. Also, an imaging portion of copiers, facsimile machines and other similar optical instruments reads (scans) a flat document either by moving the line sensor over the document or moving the document placed close to the line sensor.

In this case, any dust attaching to a beam incident portion of the line sensor might appear in scanned images.

With a reader of a facsimile machine designed to scan and read a document or a reader of a so-called skim copier which reads a document during transport from an automatic document feeder, a dust particle can appear as a continuous line image running in a document feed direction, impairing the image quality greatly.

Image quality can be restored if such dust is wiped off manually, but regarding dust which attaches during use, there is no way other than making checks after image taking.

Images of foreign particles will appear in images taken or scanned in the meantime, requiring software-based correction.

Also, with a copier, which prints out images on a paper medium at the same time, a great deal of labor is required for the correction of the printouts.

To deal with this problem, Japanese Patent Application Laid-Open No. 2008-207170 proposes a foreign particle removal apparatus which can move foreign particles in a desired direction by exciting a traveling wave in a vibration member equipped with an optical member.

FIG. 14A is a schematic diagram illustrating a configuration of the foreign particle removal apparatus disclosed in Japanese Patent Application Laid-Open No. 2008-207170. The foreign particle removal apparatus proposed in Japanese Patent Application Laid-Open No. 2008-207170 is equipped with a vibration member 501. The vibration member 501 is installed on an incident side of an imaging device 503.

The vibration member 501 includes an optical member 502 which is an elastic body as well as piezoelectric elements 101a and 101b which are electro-mechanical energy conversion elements. The piezoelectric elements 101a and 101b are placed by being shifted in a direction along which nodal lines of an out-of-plane bending vibration of the vibration member 501 are arranged.

Alternating voltages identical in frequency but 90° out of phase with each other are applied to the piezoelectric elements 101a and 101b.

The frequency of the alternating voltages applied is located between a resonance frequency of an mth-order (m is a natural number) vibration mode deformed out-of-plane along a longitudinal direction of the vibration member 501 and a resonance frequency of an (m+1)th-order vibration mode.

A vibration of the mth-order vibration mode and a vibration of the (m+1)th-order vibration mode are excited at a same amplitude and with a same vibration period on the vibration member 501, where the mth-order vibration has a resonant response and the (m+1)th-order vibration has a 90° temporal phase difference (90° phase-advanced with respect to an mth-order out-of-plane bending vibration).

A composite vibration (traveling wave) is generated on the vibration member 501 by a combination of the vibrations of the two vibration modes. The composite vibration moves foreign particles on a surface of the vibration member 501 in a desired direction.

FIG. 14B illustrates a control apparatus of the above-described foreign particle removal apparatus.

In response to a drive command from a main unit of an imaging apparatus (not shown), a controller 604 sends phase information, frequency information and pulse width information, which are parameters for alternating voltage signals, to pulse generating circuits 603a and 603b.

Digital alternating voltage signals output from the pulse generating circuits 603 are input to switching circuits 602a and 602b, and are output as analog alternating voltages Vi based on a voltage output from a power source circuit 605.

The alternating voltages Vi are input to driving circuits 601a and 601b, output as alternating voltages Vo, and applied, respectively, to the piezoelectric elements 101a and 101b installed in the vibration member 501.

### SUMMARY OF THE INVENTION

In the prior art described above, voltage amplitudes of the inputted alternating voltages Vi are boosted to desired voltages by the driving circuits 601 and subjected to conversion from rectangular forms into sine waveforms. Then, the alternating voltages Vo are output. In order to excite an ideal traveling wave or standing wave on the vibration member 501, desirably the alternating voltages Vo have sine waveforms free of distortion caused by harmonic signals and become constant voltages in the frequency band used.

However, in the driving circuits of the foreign particle removal apparatus according to the prior art, harmonic signals are produced in the alternating voltages Vo applied to the piezoelectric elements 101.

These harmonic signals affect vibrations excited on the vibration member 501, resulting in degradation of foreign particle removal performance due to traveling wave disturbances and damage to the optical member 502 due to increases in vibration amplitude.

Also, in the frequency band used, the driving circuits of the foreign particle removal apparatus according to the prior art have a large amplitude change in the alternating voltages Vo applied to the piezoelectric elements 101, i.e., a large inclination in frequency characteristics of the alternating voltages Vo, in the vicinity of a resonance frequency of the vibration member 501.

Consequently, if resonance frequency of the vibration member 501 varies due to individual differences or changes during driving, the alternating voltages Vo fluctuate greatly.

When the alternating voltages become higher than necessary, increased current can cause an increase in power consumption and increased vibration amplitude excited on the vibration member 501 can cause damage to the optical member 502.

On the other hand, when the alternating voltages are lower than required voltages, the out-of-plane bending vibration excited on the vibration member 501 does not have a sufficient vibration amplitude, resulting in degradation of foreign particle removal performance.

FIG. 14C illustrates a configuration of the driving circuit 601 according to the prior art described above.

When an inductor 102 is connected in series with the piezoelectric element 101 as shown in FIG. 14C, electrostatic capacity of the piezoelectric element 101 and the inductor 102 form an LC series resonance circuit.

The voltage amplitude of the alternating voltage Vi is boosted to a desired voltage by the LC series resonance circuit, and consequently an alternating voltage Vo is output.

FIG. 15 illustrates frequency characteristics of the voltage amplitude of the alternating voltage Vo in the case where the conventional driving circuit is used.

The abscissa represents frequency (110 kHz to 140 kHz) and the ordinate represents the voltage amplitude (50 V to 350 V).

The plots represent the characteristics in the case where the value of the inductor 102 is varied from 40 μH to 90 μH.

In FIG. 15, f(m) is the resonance frequency of an mth-order out-of-plane bending vibration and f(m+1) is the resonance frequency of an (m+1)th-order out-of-plane bending vibration.

Frequency fd of the alternating voltage Vo applied to the piezoelectric element 101 is set to f(m)<fd<f(m+1).

It can be seen from FIG. 15, that the larger the inductance value of the inductor 102, the larger the fluctuations of the voltage amplitude in the vicinity of the frequency fd.

Therefore, conventionally the fluctuations of the voltage amplitude are designed to be reduced by reducing the inductance value.

However, this provides a low boost ratio for the alternating voltage and increases the harmonic signals.

FIG. 16 illustrates frequency changes in electric resonance of the alternating voltage Vo with an inductance value in the case where the conventional driving circuit is used.

The abscissa represents frequency (120 kHz to 240 kHz) and the ordinate represents voltage amplitude (10 V to 1 MV).

The plots represent the characteristics in the case where the value of the inductor 102 is varied from 90 μH to 40 μH.

It can be seen from FIG. 16, that as the inductance value is reduced, the electric resonance due to LC series resonance shifts to a high-frequency range.

This increases the voltage amplitude in the harmonic frequency range shown in FIG. 16, increasing harmonic components contained in a rectangular wave of the inputted alternating voltage Vi. Consequently, in the outputted alternating voltage Vo, harmonic waves are superimposed on a fundamental wave of the drive frequency fd, causing distortion to an output waveform.

Next, the aforementioned harmonic waves will be described. FIG. 17 illustrates measurement data on voltage amplitudes of a fundamental wave and 3rd harmonic wave resulting from Fourier analysis of the alternating voltage Vo in the case where the conventional driving circuit is used.

The abscissa represents a pulse duty ratio of the alternating voltage Vi and the ordinate represents the voltage amplitude of the alternating voltage Vo.

It can be seen from FIG. 17 that the voltage amplitude of the 3rd harmonic wave has peaks when the pulse duty ratio is around 50% and 20%. The ratio of the 3rd harmonic wave to the fundamental wave is 31% when the pulse duty ratio is 50%, and 53% when the pulse duty ratio is 20%.

When the pulse duty ratio is less than 20%, the ratio of the 3rd harmonic wave to the fundamental wave increases further.

The results are actual measured data and a main harmonic component is a 3rd harmonic wave. However, other than the 3rd harmonic wave, according to a formula for the Fourier transform from a rectangular wave derived based on the pulse duty ratio into a sine wave, 5th, 7th, and other odd-order harmonic waves are generated as well.

The above-mentioned Fourier transform formula is a commonly used mathematical expression, and thus description thereof will be omitted. Vibrations excited on the vibration member 501 when the harmonic signals are applied to the piezoelectric element 101 also produce harmonic waves.

This results in degradation of foreign particle removal performance due to traveling wave disturbances and damage to the optical member 502 due to increases in vibration amplitude. A similar problem of reduced drive efficiency occurs in controlling the driving of vibration apparatus other than foreign particle removal apparatus.

In view of the above problems, the present invention provides a driving circuit for a vibration apparatus, the driving circuit being capable of reducing harmonic components of an alternating voltage applied to an electro-mechanical energy conversion element, improving the efficiency of driving objects such as foreign particles, reducing fluctuations of the alternating voltage applied to the electro-mechanical energy conversion element even if resonance frequency of a vibration member varies or changes during driving in the frequency band used, and outputting a stable voltage amplitude.

According to one aspect of the present invention, provided thereby is a drive circuit of a vibration apparatus for driving an object by a vibration wave of a vibration member comprising an elastic body and an electro-mechanical energy conversion element being supplied with an alternating voltage for generating the vibration wave, wherein the drive circuit comprises: a plurality of inductors serially connected to the electro-mechanical energy conversion element; and a capacitor having one end connected between the plurality of inductors, and being connected in parallel to the electro-mechanical energy conversion element, and wherein an electrostatic capacity of the electro-mechanical energy conversion element, the plurality of inductors, and the capacitor form an electric resonance circuit, the resonance circuit has at least first resonance frequency f1 and a second resonance frequency f2, and the first and second resonance frequencies f1 and f2 and a frequency fd of the alternating voltage meet a relation: f1<fd<f2.

The present invention can implement a driving circuit for a vibration apparatus, the driving circuit being capable of reducing harmonic components of an alternating voltage applied to an electro-mechanical energy conversion element, improving the efficiency of driving objects such as foreign particles, reducing fluctuations of the alternating voltage applied to the electro-mechanical energy conversion element even if resonance frequency of a vibration member varies or changes during driving in the frequency band used, and outputting a stable voltage amplitude.

Further features of the present invention will become apparent from the following description of exemplary embodiments with reference to the attached drawings.

### BRIEF DESCRIPTION OF THE DRAWINGS

FIGS. 1A and 1B are diagrams illustrating a configuration example of a driving circuit for a vibration apparatus according to the present invention.

FIGS. 2A and 2B are perspective views of a digital single-lens reflex camera configured to be able to be equipped with a foreign particle removal apparatus to which the present invention is applicable.

FIGS. 3A and 3B are graphs illustrating frequencies of alternating voltages applied to piezoelectric elements, amplitudes of vibrations produced in the piezoelectric elements, and voltage waveforms according to a first embodiment of the present invention.

FIG. 4 is a diagram illustrating displacement of a 10th-order out-of-plane bending vibration, displacement of 11th-order out-of-plane bending vibration, and layout of piezoelectric elements, where the vibrations are excited on a vibration member according to the first and second embodiments of the present invention and the displacements cause out-of-plane deformations along a longitudinal direction.

FIG. 5 is a diagram illustrating simulation results which show frequency characteristics of an alternating voltage Vo by taking variations of an entire circuit element into consideration, according to the first embodiment of the present invention.

FIG. 6 is a diagram illustrating simulation results which show frequency characteristics of an alternating voltage Vo in the driving circuit according to the first embodiment of the present invention and a conventional driving circuit.

FIGS. 7A and 7B are diagrams illustrating measured output waveforms of the alternating voltage Vo in the driving circuit according to the first embodiment of the present invention and the conventional driving circuit.

FIG. 8 is a diagram illustrating frequency characteristics of voltage amplitude of the alternating voltage Vo in the vicinity of drive frequency in the driving circuit according to the first embodiment of the present invention and the conventional driving circuit.

FIG. 9 is a diagram illustrating measured foreign particle removal ratios in the driving circuit according to the first embodiment of the present invention and the conventional driving circuit.

FIGS. 10A and 10B are graphs illustrating frequencies of alternating voltages applied to piezoelectric elements, amplitudes of vibrations produced in the piezoelectric elements, and voltage waveforms during standing wave driving according to the second embodiment of the present invention.

FIG. 11 is a diagram illustrating a control apparatus for a traveling-wave vibration type actuator according to a third embodiment of the present invention.

FIGS. 12A, 12B and 12C are diagrams illustrating an application example of the vibration type actuator according to the third embodiment of the present invention.

FIG. 13 is a diagram illustrating a configuration of a driving circuit equipped with a transformer, according to the third embodiment of the present invention.

FIG. 14A is a perspective view illustrating a structure of an imaging portion of a camera body equipped with a foreign particle removal apparatus according to a prior art, FIG. 14B is a diagram illustrating a control apparatus for the foreign particle removal apparatus according to the prior art, and FIG. 14C is a diagram illustrating a configuration of a driving circuit according to the prior art.

FIG. 15 is a diagram illustrating frequency characteristics of voltage amplitude of the alternating voltage Vo in the case where the driving circuit according to the prior art is used.

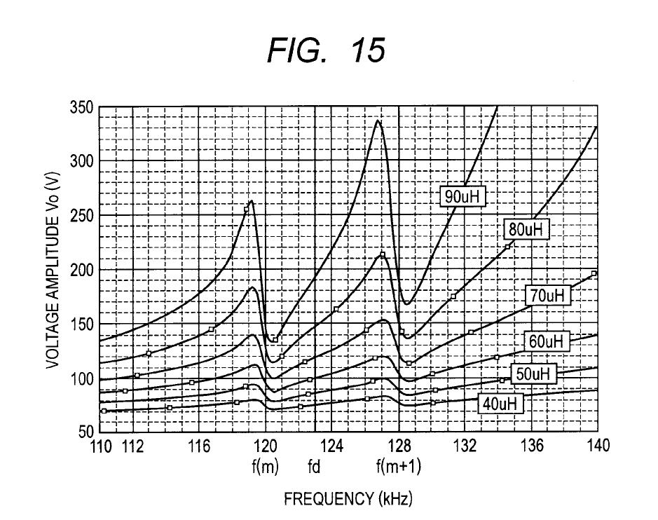

FIG. 16 is a diagram illustrating frequency changes in electric resonance of the alternating voltage Vo with inductance value in the case where the driving circuit according to the prior art is used.

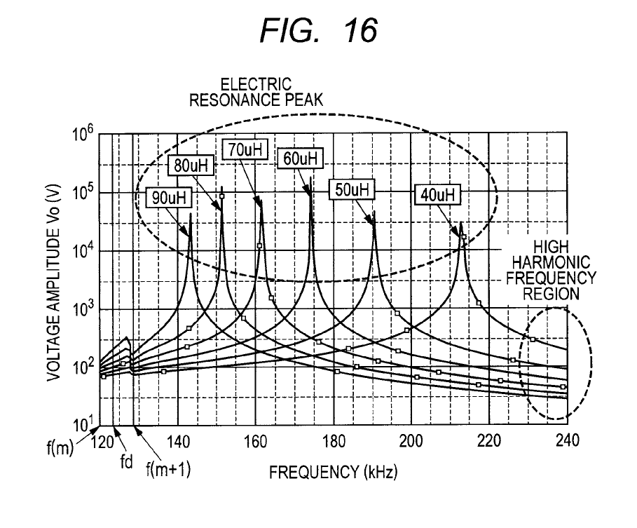

FIG. 17 is a diagram illustrating measurement data on voltage amplitudes of a fundamental wave and 3rd harmonic wave resulting from Fourier analysis of the alternating voltage Vo in the case where the driving circuit of the conventional type is used.

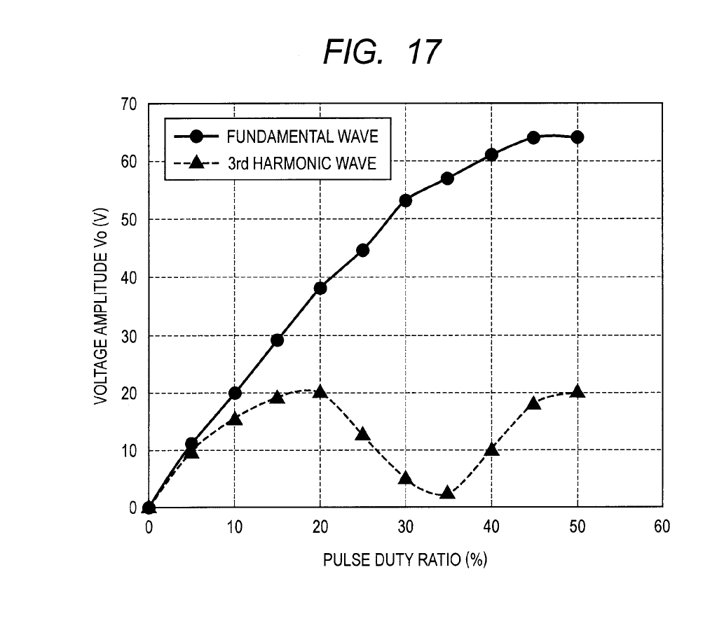

### DESCRIPTION OF THE EMBODIMENTS

Preferred embodiments of the present invention will now be described in detail in accordance with the accompanying drawings.

Next, a configuration example of a driving circuit for a vibration apparatus according to embodiments of the present invention will be described. According to the present invention, examples of the vibration apparatus include foreign particle removal apparatus and powder transport apparatus as well as vibration type actuators adapted to relatively move a movable body. That is, according to the present invention, objects driven by the vibration apparatus can be powder such as foreign particles, and movable bodies.

### First Embodiment

In a first embodiment, description will be given of a configuration example in which a driving circuit for a vibration apparatus according to the present invention is mounted as a foreign particle removal apparatus in a camera which is an optical instrument (i.e., in this example, the vibration apparatus is used as a foreign particle removal apparatus).

Incidentally, although a configuration example in which a vibration apparatus is mounted in a camera is described in the present embodiment, this is not restrictive.

Moreover, the present invention is applicable to a driving circuit of a foreign particle removal apparatus provided in another optical instrument such as a facsimile machine, a scanner, a projector, a copier, a laser beam printer, an inkjet printer, a lens, binoculars or an image display apparatus.

A driving circuit for a vibration apparatus according to the present embodiment is configured to apply alternating voltages to piezoelectric elements which are electro-mechanical energy conversion elements, generate vibration waves on a vibration member made up of the conversion elements and an elastic body bonded to the conversion elements, and drive an object using the vibration waves.

This will be described more concretely below with reference to drawings.

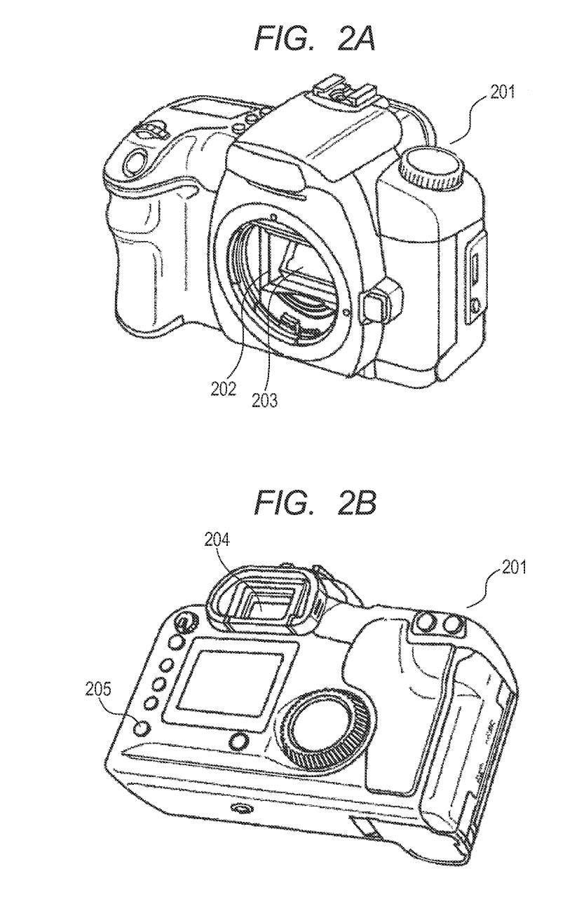

FIG. 2A is a front perspective view of a digital single-lens reflex camera with a taking lens removed, as viewed from the side of the subject, where the digital single-lens reflex camera is configured to be able to incorporate the foreign particle removal apparatus and its driving circuit according to the present embodiment.

FIG. 2B is a rear perspective view of the camera as viewed from the side of the photographer.

A mirror box 202 is installed in a camera body 201. A photographic light flux passing through a taking lens (not shown) is led to the mirror box 202. A main mirror (quick return mirror) 203 is disposed in the mirror box 202.

An imaging portion equipped with the foreign particle removal apparatus is installed on a camera optical axis passing through the taking lens (not shown).

The main mirror 203 can have a state of being held at an angle of 45° to the camera optical axis in order for a photographer to observe a subject image through a viewfinder eyepiece 204 and a state of being held at a position retracted from the photographic light flux in order to lead the photographic light toward an imaging device.

A cleaning switch 205 is provided on the back of the camera to cause the foreign particle removal apparatus to be driven. The photographer can press the cleaning switch 205 to direct a controller to drive the foreign particle removal apparatus.

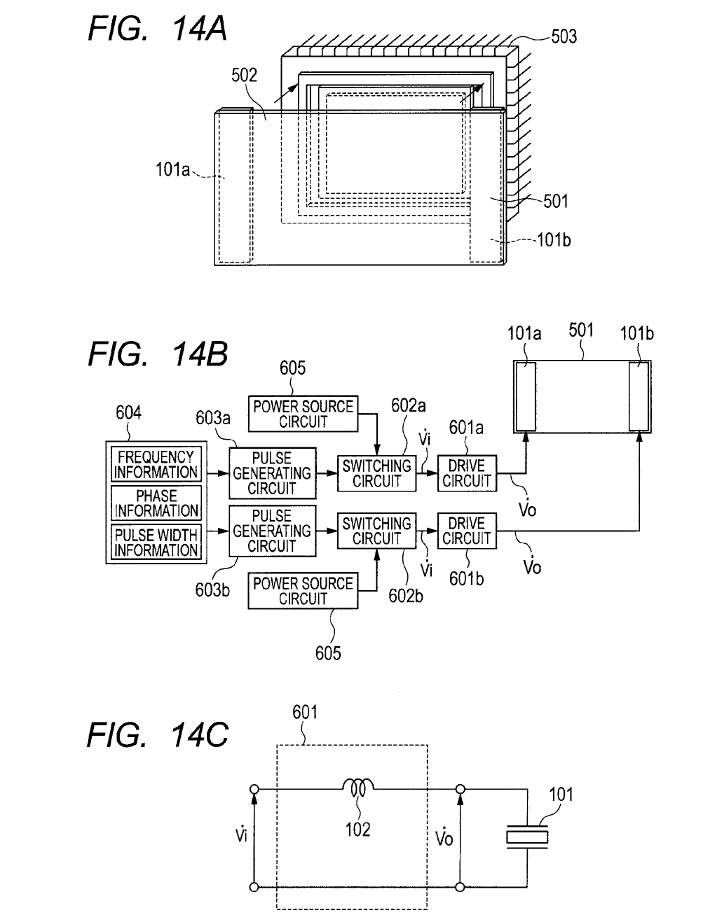

The imaging portion of the camera body 201 according to the present embodiment can be equipped with a foreign particle removal apparatus of basically the same configuration as the one shown above in FIG. 14A, and the configuration of the foreign particle removal apparatus will be described with reference to FIG. 14A.

An imaging device 503 is installed in the imaging portion of the camera body 201, where the imaging device 503 is a light-receiving element such as a CCD or CMOS sensor adapted to convert an optically received subject image into an electrical signal and thereby create image data.

Also, a vibration member 501 shaped as a rectangular plate is mounted in such a way as to hermetically seal a space on a front side of the imaging device 503.

The foreign particle removal apparatus includes at least the vibration member 501. The vibration member 501 includes an optical element 502 and a pair of piezoelectric elements 101a and 101b, where the optical element 502 is an elastic body shaped as a rectangular plate while the piezoelectric elements 101a and 101b are electro-mechanical energy conversion elements adhesively bonded to opposite end portions of the optical element 502.

According to the present embodiment, the optical member 502 is made up of a high-transmittance optical member such as cover glass, an infrared cut filter, or an optical low pass filter and configured such that light passing through the optical member 502 will enter the imaging device 503.

The piezoelectric elements 101a and 101b placed in opposite end portions of the optical member 502 are equal in size in the thickness direction (in the direction perpendicular to the plane of the paper in FIG. 14A) to the optical member 502 so as to produce bending deformation of vibration with a larger force.

Hereinafter, when it is not particularly necessary to distinguish between the piezoelectric elements 101a and 101b, they will be referred to simply as the “piezoelectric element(s) 101.”

Except for a concrete configuration of the driving circuit, a control apparatus for the foreign particle removal apparatus according to the present embodiment has basically the same configuration as the control apparatus shown above in FIG. 14B, and thus the basic configuration of the control apparatus will be described with reference to FIG. 14B.

According to the present embodiment, a controller 604 sends frequency information, phase information and pulse width information to pulse generating circuits 603a and 603b as parameters for alternating voltage signals.

For example, typical digital oscillators are used as the pulse generating circuits.

A frequency is established in the vicinity of an intermediate value between resonance frequencies of two out-of-plane bending vibrations generated on the vibration member 501 and is set equally on both pulse generating circuits 603a and 603b.

Phase values different from each other are input in the pulse generating circuits 603a and 603b so as to output alternating voltage signals 90° out of phase with each other.

Pulse widths (pulse duty ratios) are adjusted as appropriate to obtain desired voltage amplitudes and are set individually on the pulse generating circuits 603a and 603b.

Digital alternating voltage signals output from the pulse generating circuits 603 are input to switching circuits 602a and 602b, and are output as analog alternating voltages Vi based on a voltage output from a power source circuit 605.

A typical DC power source circuit or DC-DC converter circuit can be used as the power source circuit. Also, a typical H bridge circuit can be used for the switching circuits.

The alternating voltages Vi are input to respective driving circuits 601a and 601b, and then output as alternating voltages Vo after their voltage amplitudes are boosted and converted into sine waveforms.

The alternating voltages Vo are applied respectively to the piezoelectric elements 101a and 101b, generating two out-of-plane bending vibrations simultaneously on the vibration member 501. A composite vibration of the two out-of-plane bending vibrations becomes a traveling wave and moves foreign particles on a surface of the optical member 502 in a desired direction.

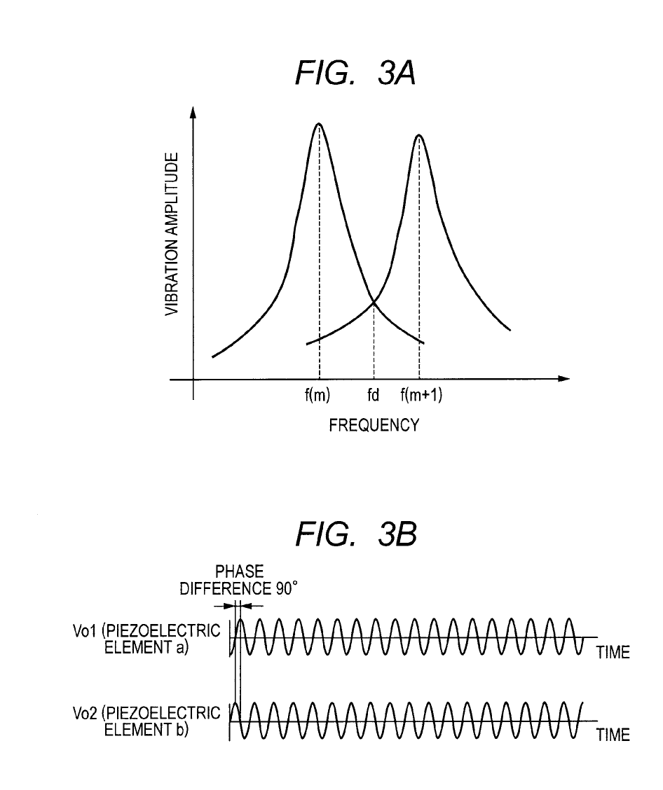

Next, description will be given of how drive frequency is set by the control apparatus according to the present embodiment. FIG. 3A is a graph illustrating frequencies of alternating voltages applied to the piezoelectric elements 101 and amplitudes of vibrations produced in the piezoelectric elements 101.

In FIG. 3A, f(m) is the resonance frequency of an mth-order out-of-plane bending vibration and f(m+1) is the resonance frequency of an (m+1)th-order out-of-plane bending vibration.

When frequency fd of the alternating voltages applied to the piezoelectric elements 101 is set to f(m)<fd<f(m+1), a vibration of the frequency fd is generated with the amplitude increased by resonance of an mth-order out-of-plane bending vibration and resonance of an (m+1)th-order out-of-plane bending vibration. Time periods of the vibrations are the same.

On the other hand, the farther the frequency fd of the alternating voltages applied to the piezoelectric elements 101 falls below f(m), the smaller the amplitude of the (m+1)th-order out-of-plane bending vibration becomes while the farther the frequency fd rises above f(m+1), the smaller the amplitude of the mth-order out-of-plane bending vibration becomes.

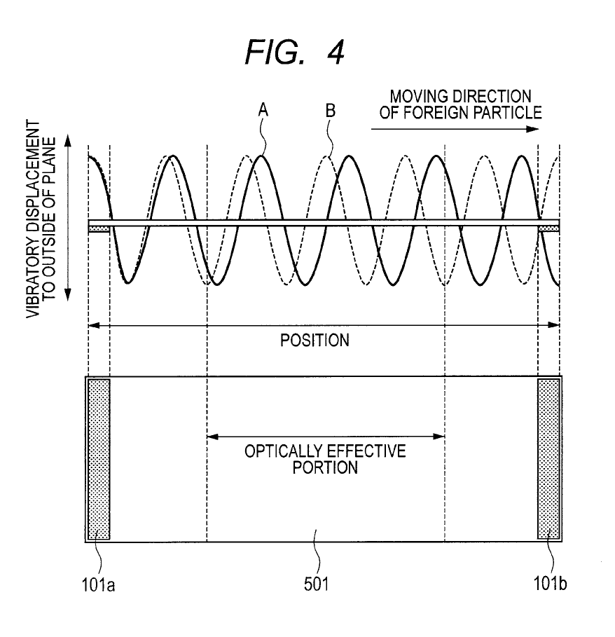

FIG. 4 is a diagram illustrating displacement of a 10th-order out-of-plane bending vibration, displacement of an 11th-order out-of-plane bending vibration, and layout of the piezoelectric elements 101a and 101b, where the vibrations are excited on the vibration member 501 and the displacements cause out-of-plane deformations along a longitudinal direction.

The abscissa represents longitudinal position of the vibration member 501 and the ordinate represents out-of-plane vibration displacement.

In FIG. 4, a 10th-order out-of-plane bending vibration is indicated by a waveform A (solid line) as a first vibration mode and an 11th-order out-of-plane bending vibration is indicated by a waveform B (broken line) as a second vibration mode. The first vibration mode A and second vibration mode B are out-of-plane bending vibration modes in which the vibration member 501 undergoes bending deformation toward a thickness direction of the optical member 502.

As the alternating voltages Vo described above are applied respectively to the piezoelectric elements 101a and 101b, vibrations of the first vibration mode A and second vibration mode B are generated simultaneously on the vibration member 501.

Incidentally, although in the present embodiment, as minimum necessary vibration modes to remove foreign particles, a 10th-order bending vibration mode is used as the first vibration mode and an 11th-order bending vibration mode is used as the second vibration mode, this is not restrictive.

In this case, an optically effective portion corresponding to the imaging device 503 is a range indicated in FIG. 4.

In the first vibration mode A, the left and right ends of a deformed shape are opposite in phase (have a phase difference of 180°). On the other hand, in the second vibration mode B, the left and right ends of a deformed shape are in phase with each other (have a phase difference of 0°).

That is, if the phase difference of the alternating voltages applied to the piezoelectric element 101a and piezoelectric element 101b is set to 180°, only the first vibration mode A is generated. Conversely, if the phase difference is set to 0°, only the second vibration mode B is generated.

Therefore, if the phase difference is set to 90°, the first vibration mode A and second vibration mode B can be generated simultaneously, generating a traveling wave of a composite vibration in the right direction in FIG. 4.

FIG. 3B is a diagram illustrating an example of alternating voltages applied to the respective piezoelectric elements to excite vibration modes of different orders simultaneously.

An alternating voltage Vo1 has a voltage waveform applied to the piezoelectric element 101a and an alternating voltage Vo1 has a voltage waveform applied to the piezoelectric element 101b. The ordinate represents voltage amplitude and the abscissa represents time.

The alternating voltages Vo1 and Vo1 are fixed to the frequency fd described above and are 90° out of phase with each other. However, the phase difference is not limited to 90° as long as the alternating voltages have different phases.

With the foreign particle removal apparatus, foreign particles attached to the surface of the optical member 502 move by being flipped by a force acting in a direction normal to the surface of the optical member 502 when thrown up out-of-plane by the optical member 502.

That is, at each phase during a drive frequency cycle, when velocity of composite vibration displacement of the vibration member 501 is positive, the foreign particles are thrown up out-of-plane and moved under the force acting in a direction normal to the direction of the composite vibration displacement in this phase.

If vibrations are applied repeatedly to foreign particles attached to a surface of an effective portion of the optical member 502, the foreign particles can be removed by being moved in the right direction in FIG. 4.

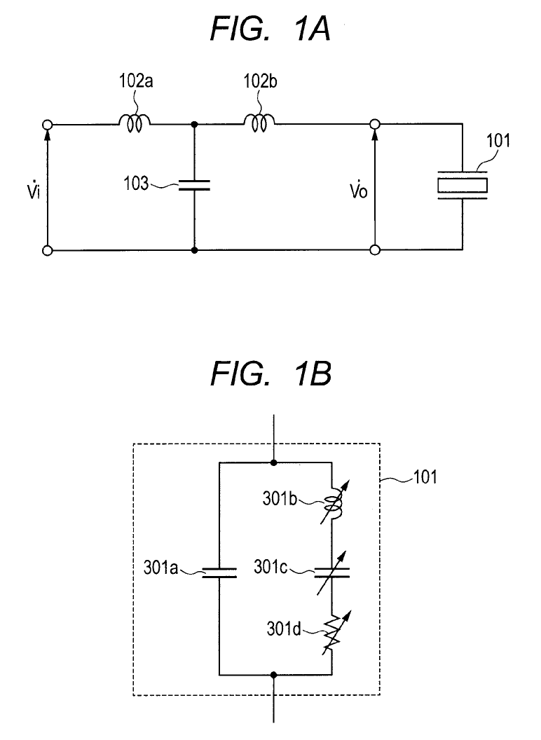

A concrete configuration of the driving circuit according to the present embodiment resulting from application of features of the present invention will be described with reference to FIGS. 1A and 1B.

FIG. 1A is a diagram illustrating a driving circuit applicable to a foreign particle removal apparatus.

In the configuration of the driving circuit, two inductors 102a and 102b are connected in series with the piezoelectric element 101 (i.e., in series with the electro-mechanical energy conversion element). Furthermore, a capacitor 103 is connected in parallel with the piezoelectric element 101, being connected at one end between the two inductors 102a and 102b described above.

These components make up an electrical resonance circuit.

Inductive elements such as coils can be used as the inductors 102a and 102b.

Also, a capacitive element such as a film capacitor can be used as the capacitor 103.

This configuration is characterized in that two electrical resonances of the circuit are produced by the inductors 102a and 102b and capacitor 103 as well as by an electrostatic capacity 301a of the piezoelectric element 101 and that the drive frequency is established between the electrical resonances.

Now, an equivalent circuit of the piezoelectric element 101 will be described with reference to FIG. 1B.

FIG. 1B expresses the piezoelectric element 101 by means of an equivalent circuit.

The equivalent circuit of the piezoelectric element 101 includes an RLC series circuit (an equivalent coil 301b of self inductance Lm, an equivalent capacitor 301c of electrostatic capacitance Cm, and an equivalent resistor 301d of resistance Rm) corresponding to a mechanical vibratory portion of the vibration member 501 as well as a capacitor 301a corresponding to electrostatic capacity Cd of the piezoelectric element 101 connected in parallel with the RLC series circuit.

A method for designing the two inductors 102a and 102b and the capacitor 103 will be described below with reference to FIGS. 1A and 1B.

According to the present embodiment, the inductor 102a is set to 135 μH, the inductor 102b is set to 180 μH, and the capacitor 103 is set to 17 nF.

These design values vary with the electrostatic capacity Cd of the piezoelectric element 101 as well as with the resonance frequencies f(m) and f(m+1) of the vibration member 501, which will be defined now.

It is assumed here that the electrostatic capacity Cd of the piezoelectric element 101 is 10.78 nF, that f(m) is 120 kHz, and that f(m+1) is 128 kHz.

Also, it is assumed that the drive frequency fd is 123 kHz.

In a first step of design, a capacitance value of the capacitor 103 is determined.

Appropriate preset values are used for two inductance values and the capacitance value is adjusted to obtain a desired boost ratio.

From the perspective of the boost ratio, desirably the capacitance value is set equal to or larger than the electrostatic capacity Cd of the piezoelectric element 101.

The larger the capacitance value, the higher the boost ratio tends to be.

Incidentally, the larger the capacitance value, the smaller the two inductance values can be set.

Conversely, the smaller the capacitance value, the larger the two inductance values need to be set.

For example, if the capacitor 103 is set to 28 nF, the inductor 102a is set to 95 μH and the inductor 102b is set to 120 μH.

When the capacitance value is set, two electrical resonance frequencies are generated: a first resonance frequency f1 and second resonance frequency f2. These frequencies need to be adjusted next.

In a second step of design, the inductance values of the two inductors 102a and 102b are determined.

The two inductances are adjusted based on the frequencies of the electrical resonances f1 and f2.

The inductance value of the inductor 102a allows f1 to be adjusted and the inductance value of the inductor 102b allows f2 to be adjusted.

If the inductance value of the inductor 102b is made larger than the inductance value of the inductor 102a, f1 and f2 can be adjusted to be desired frequencies.

Also, the capacitance value of the capacitor 103 allows f1 and f2 to be shifted in the same direction.

The adjustment method described above determines the two inductance values such that the drive frequency fd will satisfy the relationship of the expression below.

f1<fd<f2

In the present embodiment, f1 is set to 72.5 kHz and f2 is set to 165 kHz.

The reason why a difference of somewhere around 50 kHz is provided between f1 and fd as well as between f2 and fd is to prevent the effects of fluctuations in the frequencies of electrical resonances caused by variations in inductors and capacitors.

Furthermore, the frequency difference may be increased, but then, the boost ratio tends to decrease.

As f1 and f2 have approximately equal frequency differences from the drive frequency fd, changes in the voltage amplitude in the vicinity of fd can be made gentle.

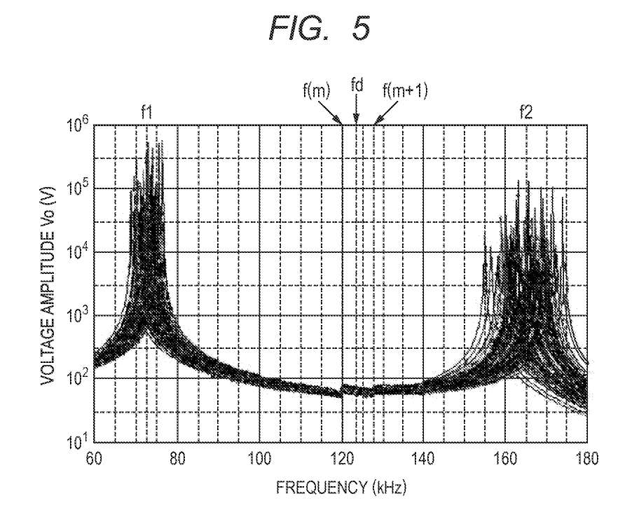

FIG. 5 illustrates simulation results which show frequency characteristics of the alternating voltage Vo by taking variations of an entire circuit element into consideration, according to embodiments of the present invention.

The abscissa represents frequency (60 kHz to 180 kHz) and the ordinate represents voltage amplitude (10 V to 1 MV).

Assuming that variations of the inductors 102a and 102b are ±20%, that variations of the capacitor 103 are ±10%, and that variations in the electrostatic capacity Cd of the piezoelectric element are ±10%, random number calculations were performed on a uniform distribution using the Monte Carlo method.

As can be seen from FIG. 5, f1 fluctuates ±5 kHz from the design value and f2 fluctuates ±10 kHz from the design value.

Therefore, to prevent the voltage amplitude of the alternating voltages Vo from being affected by the fluctuations, a difference of somewhere around 50 kHz each from fd is provided. This allows the frequency characteristics of the alternating voltages Vo to be made gentle in the vicinity of the drive frequency fd as can be seen from FIG. 5.

Thus, even if there are variations in the resonance frequency of the vibration member 501 or changes occur in the resonance frequency of the vibration member 501 during driving, fluctuations in the alternating voltages applied to piezoelectric elements are small, enabling output of stable voltage amplitudes.

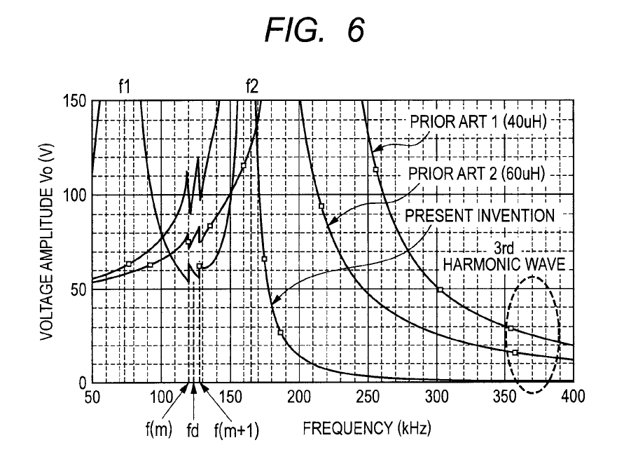

FIG. 6 illustrates simulation results which show frequency characteristics of the alternating voltage Vo in the driving circuit according to the present embodiment and a conventional driving circuit which is provided as a comparative example.

The abscissa represents frequency (50 kHz to 400 kHz) and the ordinate represents voltage amplitude (0 V to 150 V).

For comparison, results obtained using the conventional driving circuit in FIG. 14C are shown together.

In FIG. 6, prior art 1 shows a result obtained using a 40-μH inductor and prior art 2 shows a result obtained using a 60-μH inductor.

The vibration member 501 according to the present embodiment uses two out-of-plane bending vibrations, and thus two resonance frequencies fm are f(m) and f(m+1).

In the simulation, the self inductance Lm of the equivalent coil 301b was set to 0.04H and the electrostatic capacitance Cm of the equivalent capacitor 301c was set to 44 pF.

Also, f(m) was set to 120 kHz, f(m+1) was set to 128 kHz, and the drive frequency was set to fd=123 kHz.

In the embodiment of the present invention, the inductor 102a is set to 135 μH, the inductor 102b is set to 180 μH, and the capacitor 103 is set to 17 nF.

It can be seen from FIG. 6 that according to the present embodiment, the voltage amplitude is reduced greatly at 369 kHz which corresponds to the 3rd harmonic frequency of the drive frequency fd. Specifically, the voltage amplitude is 1/50 of prior art 1.

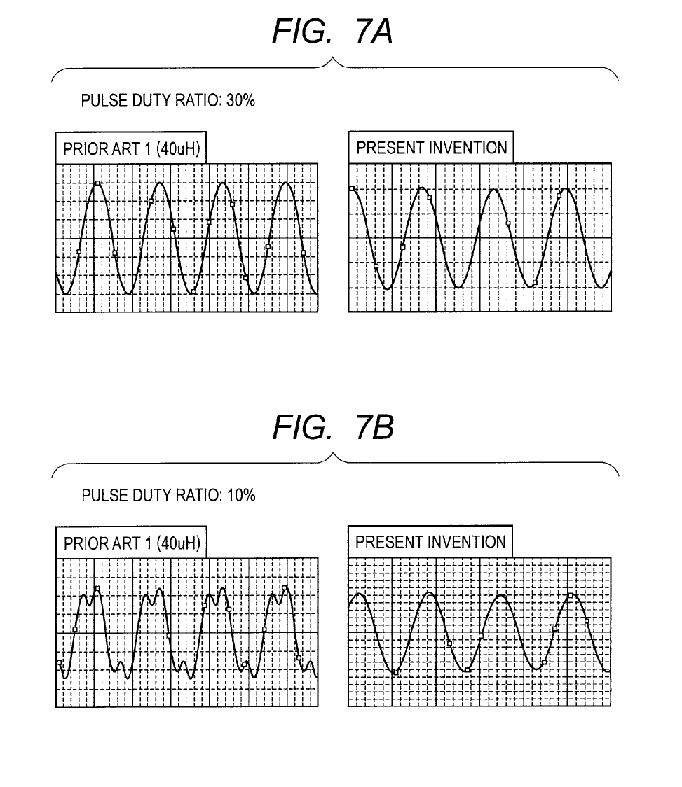

FIGS. 7A and 7B illustrate measured output waveforms of the alternating voltage Vo in the driving circuit according to the present embodiment and the conventional driving circuit. The abscissa represents time and the ordinate represents voltage amplitude.

FIG. 7A shows results obtained when the pulse duty ratio of the alternating voltage Vi is set to 30% and compares waveforms between the present embodiment and prior art 1.

Whereas in the waveform of prior art 1, a sine waveform is distorted by the influence of the 3rd harmonic wave, an ideal sine waveform is obtained in the present embodiment.

FIG. 7B shows results obtained when the pulse duty ratio of the alternating voltage Vi is set to 10%.

Whereas the waveform of prior art 1 is further deformed by the influence of the 3rd harmonic wave, the present embodiment shows an ideal sine waveform. Thus, a harmonic reduction effect of the present embodiment was confirmed experimentally.

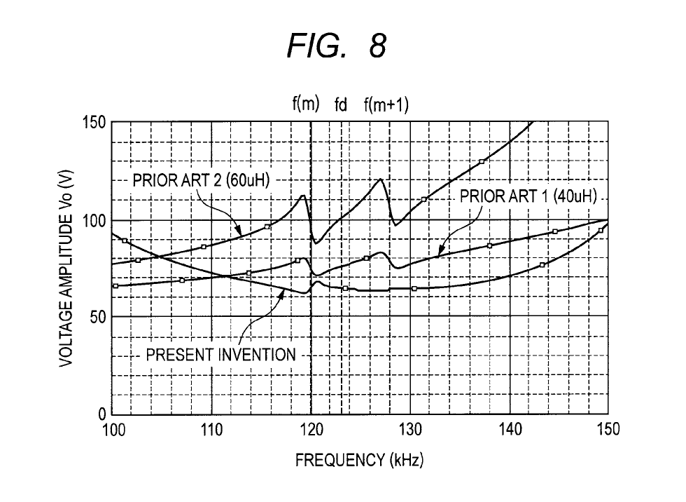

FIG. 8 is a diagram illustrating frequency characteristics of voltage amplitude of the alternating voltage Vo in the vicinity of drive frequency in the driving circuit according to the present embodiment and the conventional driving circuit.

The abscissa represents frequency (100 kHz to 150 kHz) and the ordinate represents voltage amplitude (0V to 150V).

As shown in FIG. 8, the present embodiment can make the frequency characteristics of the alternating voltage Vo gentle in the vicinity of fd as well as in the vicinity of f(m) and f(m+1).

That is, a stable voltage is applied in spite of changes in the resonance frequency of the vibration member 501. For example, when the resonance frequency f(m+1) drops with time during driving, the amplitude of the alternating voltage increases in the prior art, resulting in increases in drive current, but the present invention can reduce the changes.

In the prior art, the amplitude changes in the alternating voltage Vo in the vicinity of fm are caused by impedance changes, which in turn are caused by the self inductance Lm and electrostatic capacitance Cm of the mechanical vibratory portion of the vibration member 501.

In contrast, by using a frequency between two electrical resonances, the present embodiment can moderate impedance changes in the mechanical vibratory portion of the vibration member 501. This is believed to reduce the amplitude changes in the alternating voltage Vo as a consequence.

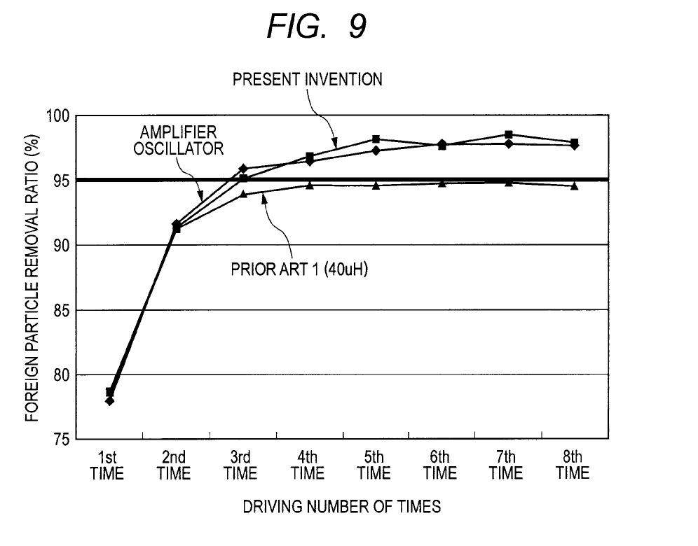

FIG. 9 is a diagram illustrating measured foreign particle removal ratios in the driving circuit according to the present embodiment and the conventional driving circuit. The abscissa represents the driving number of times and the ordinate represents the foreign particle removal ratio.

In the present embodiment, measurements were taken as follows: powder for experimental use was attached to the surface of the optical member, the foreign particle removal apparatus was run intermittently under the same conditions with predetermined idle periods, and the powder removal ratio on the optically effective portion was measured after each driving.

A target value of the removal ratio was set to 95% and above and used as an index of removal performance.

For comparison, measurements were similarly taken both for the case of driving with an amplifier oscillator showing an ideal SIN waveform and the case where the driving circuit according to prior art 1 was used. As can be seen from FIG. 9, in prior art 1, the removal ratio did not reach 95% even after 8 runs.

In contrast, according to the present embodiment, the removal ratio exceeded 95% after 3 runs, exhibiting removal performance similar to that of the amplifier oscillator.

### Second Embodiment

As a second embodiment, a configuration example of a driving circuit for a vibration apparatus of a different form from the first embodiment will be described.

The present embodiment differs in configuration from the first embodiment in that two vibration modes are excited alternately on the vibration member 501.

Incidentally, the driving circuit of the foreign particle removal apparatus is the same as the first embodiment and the present embodiment is distinguished for a method for setting frequency information and phase information on the controller of the control apparatus.

The driving circuit according to the present embodiment will be described below with reference to FIGS. 1A and 1B.

FIG. 1A is a diagram illustrating the driving circuit of the foreign particle removal apparatus according to the second embodiment. In the configuration of the driving circuit, two inductors 102a and 102b are connected in series with the piezoelectric element 101 (i.e., in series with the electro-mechanical energy conversion element). Furthermore, a capacitor 103 is connected in parallel with the piezoelectric element 101, being connected at one end between the two inductors 102a and 102b described above.

Inductive elements such as coils can be used as the inductors 102a and 102b.

Also, a capacitive element such as a film capacitor can be used as the capacitor 103.

The present embodiment is characterized in that two electrical resonances of the circuit are produced by the inductors 102a and 102b and capacitor 103 as well as by the electrostatic capacity 301a of the piezoelectric element 101 and that the drive frequency is established between the electrical resonances.

In the present embodiment, the inductor 102a is set to 130 μH, the inductor 102b is set to 200 μH, and the capacitor 103 is set to 14 nF.

These design values are determined based on the electrostatic capacity Cd of the piezoelectric element 101 as well as the resonance frequencies f(m) and f(m+1) of the vibration member 501.

It is assumed here that the electrostatic capacity Cd of the piezoelectric element 101 is 10.78 nF, that f(m) is 120 kHz, and that f(m+1) is 128 kHz. Assuming that the drive frequency fd sweeps in a range from 150 kHz to 100 k Hz, f1 and f2 are set so as to satisfy the relationship of the expression below.

f1<fd<f2

where f1 and f2 are circuit's electrical resonance frequencies generated in the driving circuit according to the present invention.

In the present embodiment, the inductors 102a and 102b and capacitor 103 are determined such that f1 will be 72.5 kHz and that f2 will be 165 kHz.

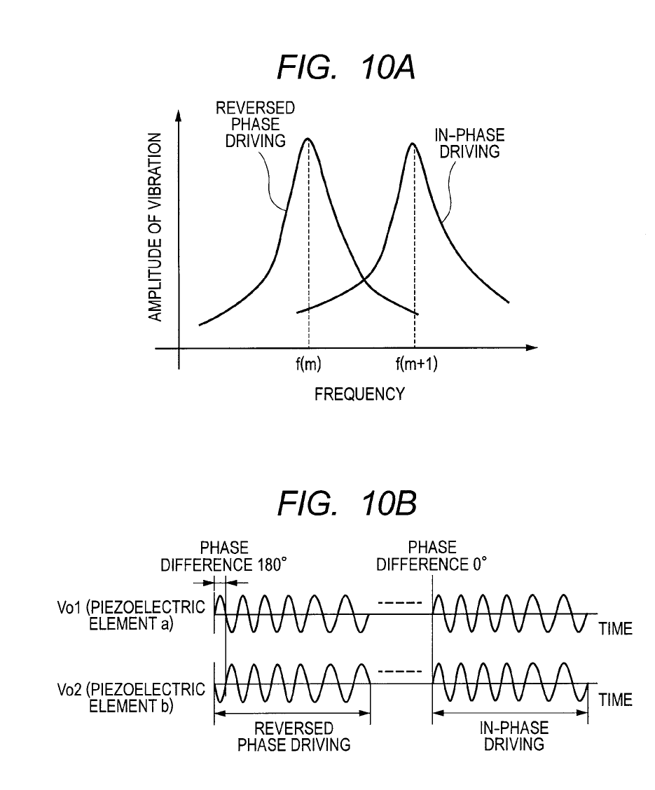

FIG. 10A is a graph illustrating frequencies of alternating voltages applied to piezoelectric elements and amplitudes of vibrations produced in the piezoelectric elements.

In the graph, f(m) is the resonance frequency of an mth-order out-of-plane bending vibration and f(m+1) is the resonance frequency of an (m+1)th-order out-of-plane bending vibration.

In FIG. 10A, f(m) occurs in a 10th-order out-of-plane bending vibration mode (vibration mode based on a first standing wave) excited by reversed phase driving and f(m+1) occurs in an 11th-order out-of-plane bending vibration mode (vibration mode based on a second standing wave) excited by in-phase driving.

In the present embodiment, the standing waves of the two vibration modes are excited alternately to remove foreign particles attached to the surface of the optical member.

FIG. 4 is a diagram illustrating displacement of a 10th-order out-of-plane bending vibration, displacement of an 11th-order out-of-plane bending vibration, and layout of the piezoelectric elements 101a and 101b, where the vibrations are excited on the vibration member 501 and the displacements cause out-of-plane deformations along a longitudinal direction.

The abscissa represents longitudinal position of the vibration member 501 and the ordinate represents out-of-plane vibration displacement. In FIG. 4, a 10th-order out-of-plane bending vibration is indicated by a waveform A (solid line) as a first vibration mode and an 11th-order out-of-plane bending vibration is indicated by a waveform B (broken line) as a second vibration mode.

The first vibration mode A and second vibration mode B are out-of-plane bending vibration modes in which the vibration member 501 undergoes bending deformation toward a thickness direction of the optical member 502. In the first vibration mode A, the left and right ends of a deformed shape are opposite in phase (have a phase difference of 180°).

On the other hand, in the second vibration mode B, the left and right ends of a deformed shape are in phase with each other (have a phase difference of 0°).

That is, if the phase difference of the alternating voltages applied to the piezoelectric element 101a and piezoelectric element 101b is set to 180°, only the first vibration mode A is excited in a resonant state. Conversely, if the phase difference is set to 0°, the second vibration mode B is excited.

FIG. 10B is a diagram illustrating an example of alternating voltages applied to respective piezoelectric elements to excite two standing wave vibrations of different orders alternately.

Regarding the control apparatus, the one described with reference to FIG. 14B is used. An alternating voltage Vo1 has a voltage waveform applied to the piezoelectric element 101a and an alternating voltage Vo2 has a voltage waveform applied to the piezoelectric element 101b. The ordinate represents voltage amplitude and the abscissa represents time.

To generate vibrations of the two vibrations modes alternately, first, alternating voltages with a frequency in the vicinity of the natural frequency of the 10th-order bending vibration mode of the vibration member 501 and a phase difference of 180° are applied to the piezoelectric elements 101a and 101b (reversed phase driving).

As the alternating voltages are applied, a 10th-order bending vibration mode is excited on the vibration member 501.

After the 10th-order bending vibration mode is excited for a predetermined time, next, alternating voltages with a frequency in the vicinity of the natural frequency of the 11th-order vibration mode of the vibration member 501 and a phase difference of 0° are applied to the piezoelectric elements 101a and 101b (in-phase driving).

As the alternating voltages are applied, an 11th-order bending vibration mode is excited on the vibration member 501. When the above driving operations are repeated, vibrations of the 10th- and 11th-order out-of-plane bending vibration modes are excited alternately.

In the above driving process, it is advisable to sweep the alternating voltages Vo1 and Vo2 gradually from the high frequency side to the low frequency side in the vicinity of each natural frequency as shown in FIG. 10B. If the frequencies of the alternating voltages are established in the vicinity of the natural frequency of the vibration member 501, a large amplitude can be obtained using low applied voltages, resulting in improved efficiency.

In this way, a vibration of the first vibration mode, when generated on the vibration member 501, provides a function to strip off foreign particles attached to the optical member 502 located on anti-nodes of the vibration of the first vibration mode.

Specifically, when an acceleration higher than adherence of the foreign particles attached to the optical member 502 is imparted to the foreign particles by the vibration of the first vibration mode, the foreign particles are stripped off the optical member 502.

Furthermore, a vibration of the second vibration mode, when generated on the vibration member 501, provides a function to strip off foreign particles attached to the optical member 502 located in the vicinity of a node position of the vibration of the first vibration mode.

The reason why standing waves of different orders are exited is to eliminate locations without amplitude from the optical member 502 by shifting node positions of the two stationary waves.

Incidentally, a standing wave of one out-of-plane bending vibration may be excited on the vibration member 501 of the foreign particle removal apparatus by applying the alternating voltage described above to only one of the piezoelectric elements 101a and 101b.

### Third Embodiment

In a third embodiment, description will be given of a configuration example in which a driving circuit for the vibration apparatus according to the present invention is applied to a vibration type actuator (i.e., an example in which the vibration apparatus is configured to be a vibration type actuator).

The driving circuit according to the present invention is widely applicable in addition to the foreign particle removal apparatus show in the first embodiment and second embodiment. For example, the driving circuit is applicable as a driving circuit of a vibration type actuator.

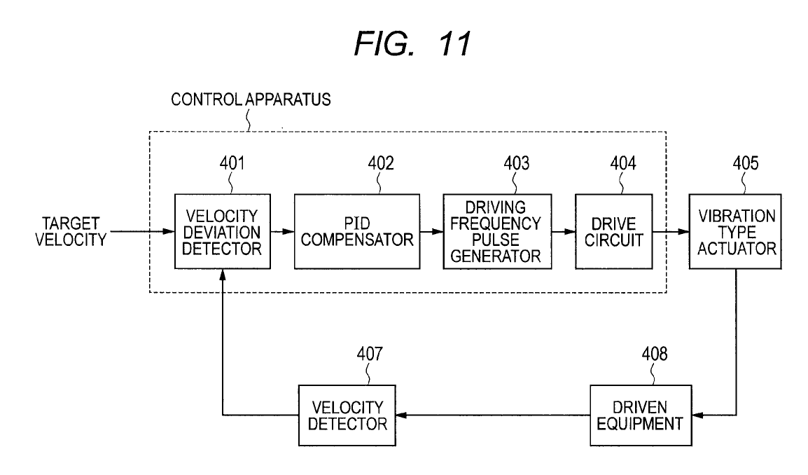

FIG. 11 shows a control apparatus in the case where a vibration type actuator is used as a vibration apparatus. As in the case of the first and second embodiments, control apparatus is equipped with at least a driving circuit.

A velocity deviation detector 401 accepts as inputs a velocity signal obtained by a velocity detector 407 such as an encoder and a target velocity from a controller (not shown) and outputs a velocity deviation signal.

The velocity deviation signal is input in a PID compensator 402 and output as a control signal. The control signal output from the PID compensator 402 is input in a drive frequency pulse generator 403.

A drive frequency pulse signal output from the drive frequency pulse generator 403 is input to a driving circuit 404, which then outputs two-phase alternating voltages with a phase difference of 90°.

The alternating voltages are two-phase alternating signals with a 90° phase shift.

The alternating voltage output from the driving circuit 404 is input in an electro-mechanical energy conversion element of a vibration type actuator 405, causing a movable body of the vibration type actuator 405 to rotate at a constant velocity. That is, the object in the present embodiment is a movable body.

A driven body 406 (such as a gear, scale, or shaft) coupled to the movable body of the vibration type actuator 405 is driven rotationally, and the velocity detector 407 detects rotational velocity and performs feedback control to keep the rotational velocity close to the target velocity.

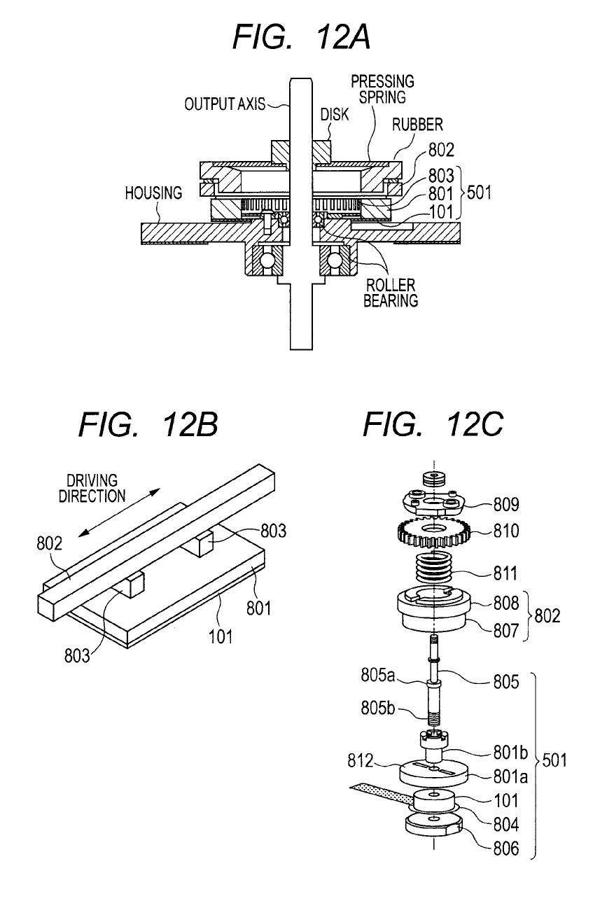

FIGS. 12A to 12C illustrate an application example of the vibration type actuator.

The vibration type actuators are divided into a standing wave type and traveling wave type according to the type of vibration generated.

First, description will be given of an example in which the driving circuit according to the present invention is applied to a traveling-wave vibration type actuator.

In the traveling-wave vibration type actuator, the vibration member is made up of a first electro-mechanical energy conversion element, a second electro-mechanical energy conversion element, and an elastic body joined to the first and second electro-mechanical energy conversion elements.

The frequencies of alternating voltages are set so as to simultaneously generate a first standing wave and second standing wave having different orders, on the vibration member.

At the same time, the alternating voltages applied, respectively, to the first and second electro-mechanical energy conversion elements are made to differ in phase.

FIG. 12A is a perspective view illustrating a traveling-wave vibration type actuator.

The vibration type actuator includes a vibration member 501 and a movable body 802, where the vibration member 501 is made up of an elastic body 801 and a piezoelectric element 101 which is an electro-mechanical energy conversion element.

The elastic body 801 fixed to a housing includes plural protrusions 803 adapted to amplify vibration amplitude and act as a driver of the movable body 802. The movable body 802 is pressed downward in FIG. 12A by a pressing spring and disk via rubber.

The components are annular in shape. When two-phase alternating voltages are applied to the piezoelectric element 101, a traveling wave is generated on the vibration member 501, and the movable body 802 placed in contact with the vibration member 501 rotates relative to the vibration member by friction drive.

An output shaft connected with a housing via a roller bearing is fixed to the movable body 802 and adapted to rotate with rotation of the movable body 802.

The driving circuit according to the present embodiment will be described taking as an example the traveling-wave vibration type actuator.

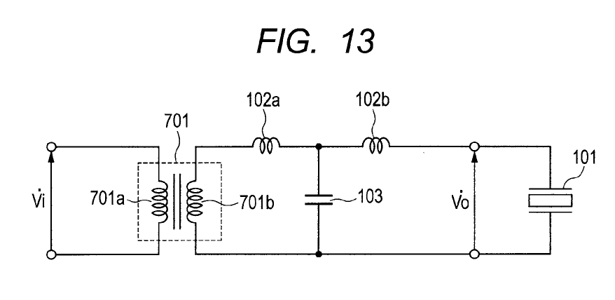

FIG. 13 illustrates a configuration of the driving circuit according to the present invention equipped with a transformer.

The present vibration type actuator drives the piezoelectric element by applying a high voltage of 400 Vpp to 500 Vpp, and thus generally uses a transformer for boosting.

For example, if a transformer with a winding ratio of 10 is used, an output of 480 Vpp can be obtained from a supply voltage of 24 V.

The alternating voltage Vi input to the driving circuit is applied to a primary coil 701a of a transformer 701 and boosted according to the winding ratio between the primary coil 701a and a secondary coil 701b of the transformer 701.

Two inductors 102a and 102b are connected in series with the secondary coil 701b of the transformer, and moreover a capacitor 103 is connected in parallel with the piezoelectric element 101.

On the secondary side of the transformer 701, harmonic waves contained in the alternating voltage signal is reduced. Consequently, the alternating voltage signal becomes an alternating voltage Vo less liable to fluctuations in the vicinity of the drive frequency. Then, the alternating voltage Vo is applied to the piezoelectric element 101.

Here, it is assumed that the resonance frequency f(m) of the vibration member is 45 kHz and that the electrostatic capacity of the piezoelectric element 101 is 3.5 nF.

The drive frequency fd is placed under frequency control within a range of 47 kHz to 50 kHz based on the velocity deviation signal.

The inductors 102a and 102b and capacitor 103 are set such that the circuit's electrical resonance frequencies f1 and f2 generated in the driving circuit according to the present invention will satisfy:

f1<fd<f2

The driving circuit according to the present invention enables greatly reducing harmonic waves in the alternating voltages Vo applied to the piezoelectric elements and provides a stable voltage amplitude less liable to fluctuations in the vicinity of the drive frequency.

This offers the advantage of suppressing useless vibrations and noise of the vibration type actuator caused by harmonic frequencies as well as improving drive efficiency and control performance.

Also, the driving circuit according to the present invention can similarly be applied to a standing-wave vibration type actuator.

In the standing-wave vibration type actuator, the vibration member is made up of a first electro-mechanical energy conversion element, a second electro-mechanical energy conversion element, and an elastic body joined to the first and second electro-mechanical energy conversion elements.

The frequencies of alternating voltages are set so as to generate a first standing wave and second standing wave having different orders, on the vibration member by temporally switching between the first standing wave and second standing wave.

At the same time, the alternating voltages applied, respectively, to the first and second electro-mechanical energy conversion elements are configured to be 0° or 180° out of phase with each other.

FIG. 12B is a perspective view illustrating a basic configuration of the standing-wave vibration type actuator.

As shown in FIG. 12B, a transducer of the vibration type actuator includes an elastic body 801 made of metal material shaped into a rectangular plate, and a piezoelectric element 101 is joined to a back side of the elastic body 801.

Plural protrusions 803 are provided at predetermined positions on top of the elastic body 801.

With this configuration, when an alternating voltage is applied to the piezoelectric element 101, a 2nd-order flexural vibration along the long side of the elastic body 801 and a 1st-order flexural vibration along the short side of the elastic body 801 are generated simultaneously, exciting an elliptical motion on the protrusions 803.

As the movable body 802 is placed in pressure contact with the protrusions 803, the movable body 802 can be driven linearly by the elliptical motion of the protrusions 803. That is, the protrusions 803 act as a driver of the movable body 802.

FIG. 12C is an exploded perspective view of a rod-shaped vibration type actuator used for autofocusing of a camera lens.

The vibration type actuator includes a vibration member 501 and movable body 802.

The vibration member 501 includes a first elastic body 801a, a flexible printed board 804, and a second elastic body 801b, where the first elastic body 801a combines a friction material and the flexible printed board 804 is used to supply power to a piezoelectric element 101 serving as an electro-mechanical energy conversion element.

These members are clamped between an abut flange 805a of a shaft 805 and a lower nut 806 fitted over a threaded portion 805b in lower part of the shaft 805.

The movable body 802 includes a contact spring 807 adhesively fixed to a rotor 808. Consequently, the movable body 802 is placed in pressure contact with a friction surface 812 of the vibration member 501 by an output gear 810 and pressing spring 811, where the output gear 810 is rotatably supported by a bearing of a flange 809.

A lower end surface of the contact spring 807 of the movable body 802 serves as a friction surface of the movable body and abuts the friction surface 812 of the first elastic body of the vibration member.

Alternating voltages are applied to the piezoelectric element 101 from a power source (not shown) via the flexible printed board 804.

Consequently, on the friction surface of the first elastic body 801a, 1st-order bending vibrations in two orthogonal directions are excited. When the vibrations are superimposed with a temporal phase difference of π/2, a rotating elliptical motion can be produced on the friction surface 812.

This moves the contact spring 807 placed in pressure contact with the friction surface, relative to the vibration member 501.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-098141, filed Apr. 26, 2011, which is hereby incorporated by reference herein in its entirety.

What is claimed is:

1. A drive circuit of a vibration apparatus for driving an object by a vibration wave of a vibration member comprising an elastic body and an electro-mechanical energy conversion element being supplied with an alternating voltage for generating the vibration wave, wherein the drive circuit comprises:
a plurality of inductors serially connected to the electro-mechanical energy conversion element; and
a capacitor having one end connected between the plurality of inductors, and being connected in parallel to the electro-mechanical energy conversion element, and wherein
an electrostatic capacity of the electro-mechanical energy conversion element, the plurality of inductors, and the capacitor form an electric resonance circuit,
the resonance circuit has at least first resonance frequency f1 and a second resonance frequency f2, and
the first and second resonance frequencies f1 and f2 and a frequency fd of the alternating voltage meet a relation:
f1<fd<f2.

2. The drive circuit according to claim 1, wherein
the plurality of inductors have mutually different inductance values, an inductance value of the inductor connected to the electro-mechanical energy conversion element is larger than an inductance value of the other inductor.

3. The drive circuit according to claim 1, wherein
the capacitor has a capacitance value equal to or larger than a value of the electrostatic capacity of the electro-mechanical energy conversion element.

4. The drive circuit according to claim 1, wherein
the vibration member comprises a first electro-mechanical energy conversion element, a second electro-mechanical energy conversion element, and the elastic body joined with the first and second electro-mechanical energy conversion elements, and
the first and second electro-mechanical energy conversion elements are respectively supplied with the alternating voltages of different phases, to generate simultaneously in the vibration member first and second standing waves of different orders.

5. The drive circuit according to claim 1, wherein
the vibration member comprises a first electro-mechanical energy conversion element, a second electro-mechanical energy conversion element, and the elastic body joined with the first and second electro-mechanical energy conversion elements, and
the first and second electro-mechanical energy conversion elements are respectively supplied with the alternating voltages of phases mutually different by 0° or 180°, to generate, in a different timing switch-ably in the vibration member, first and second standing waves of different orders.

6. The drive circuit according to claim 1, wherein
the elastic body is an optical member transmitting light.

7. The drive circuit according to claim 1, wherein
the object is power moved by the vibration wave.

8. The drive circuit according to claim 1, wherein
the vibration apparatus is a foreign particle removing apparatus moving and removing the foreign particle as the object by the vibration wave.

9. The drive circuit according to claim 1, wherein
the vibration apparatus is a vibration type actuator for moving, by the vibration wave, a moving substance as the object relatively to the vibration member.
